(19) United States
(12) Patent Application Publication
(10) Pub. No.: US 2008/0189204 A1
(43) Pub. Date: Aug. 7, 2008

(54) Method and apparatus for providing home equity financing without interest payments

(76) Inventor: Brendon N. Hansford, Cincinnati, OH (US)

Correspondence Address: Frederick H. Gribbell;FREDERICK H. GRIBBELL, LLC, 10250 Alliance Road, Suite 120, Cincinnati, OH, 45242, US

(21) Appl. No.: 10/854,120

(22) Filed: May 26, 2004

(51) Int. Cl. G06Q 40/00

(52) U.S. Cl. 705/38; 705/35

(57) ABSTRACT

A method of financing is provided for the purchase of real estate property, in which a portion of a down payment is provided by an equity financing provider, in return for a right to a portion of the future change in value of the property. The home purchaser does not make any periodic payments to the equity financing provider; only when the equity financing rights are redeemed does the equity financing provider typically receive payment. The equity financing provider also can supply similar equity financing when an existing home owner wishes to raise capital by using the existing equity in the home; instead of obtaining a second mortgage (or a home equity line of credit), the home owner can obtain equity financing from the equity financing provider, in return for a right to a portion of the future change in value of the property.

### TECHNICAL FIELD

The present invention relates generally to a method of financing for real estate and is particularly directed to method which provides equity financing to home owners and home purchasers. The invention is specifically disclosed as a method of doing business of the type involving real property, typically homes, in which a portion of a down payment is provided by an equity financing provider, and in return the equity financing provider receives a right to a portion of the future change in value of the home. The home purchaser typically obtains a mortgage for most of the purchase price and must make periodic interest and/or principal payments to the mortgage provider. However, the home purchaser does not make any periodic payments to the equity financing provider; only when the equity financing rights are redeemed does the equity financing provider receive payment, in most situations.

In one mode of the invention, if the home purchaser provides 50% of the down payment, and the equity provider provides 50% of the down payment, then the two parties split 50-50 the appreciation of the home value at a future date, typically the date the home is sold to a third party. The percentages can vary, of course. Moreover, the equity financing provider is able to supply similar equity financing in other situations, such as when an existing home owner wishes to raise capital by using the existing equity in his or her home; instead of obtaining a second mortgage (or a home equity line of credit), the home owner can obtain equity financing from the equity financing provider. In that situation, the home owner receives a monetary sum from the equity financing provider, but does not have to make any periodic payments of principal or interest back to the equity financing provider. Instead, the equity financing provider receives a right to a portion of the future increase in value of the home, which typically is not redeemed until the home is sold.

In another mode of the present invention, the equity financing provider obtains multiple rights to a portion of the change in value of multiple homes, and now is in a position to market those rights, just like mortgage providers market their existing loans in the mortgage-backed securities market. The rights held by the equity financing provider can be bought and sold like mortgage-backed bonds or other securities. As an investment vehicle, an entire market could be established for securities issued by companies in the equity financing business, and mutual funds could be created to purchase securities issued by such equity financing provider companies.

### BACKGROUND OF THE INVENTION

### Home Equity Facts

Homeowners occupy 72 million of the 105 million homes in the United States, a home ownership rate of 68%. The aggregate value of owner-occupied homes is $8.8 trillion. With mortgages averaging 55% of home value, homeowners' net equity in their homes totals some $3.9 trillion.

In a typical home purchase, the homebuyer provides a 20% down payment and the mortgage lender funds the balance. So for a home purchased for the median US home price of $170,000, the typical homebuyer is required to provide $34,000 in cash as a down payment, plus additional non-borrowed funds to cover closing and moving costs, which might typically run to an additional $10,000.

Historically, homes have been a solid if not spectacular investment. According to the Office of Federal Housing Enterprise Oversight, since 1975, home prices have risen on average by 5.7% per year. Rising home prices, the financial leverage made possible by mortgages, and the tax advantages of home ownership, have combined to deliver healthy returns for most homeowners. But investing in the equity of one's home has drawbacks:

(a) HIGH UPFRONT COST: saving enough cash for a down payment (plus closing costs) is often a struggle, particularly for first-time buyers. According to Fannie Mae's 2002 National Housing Survey, 32% of Americans say the upfront costs are a major obstacle to home ownership. Lack of upfront cash can limit how large a house a person can buy, and how quickly the person could buy it. Buyers with limited cash resources who opt for greater than 80% mortgages typically incur higher interest rates, the extra cost of private mortgage insurance (PMI), and higher monthly payments, often at a time in their lives when cashflow is constrained.

(b) ASSET CONCENTRATION RISK: By default, many homeowners' investments in their homes are their largest asset. Homes represent almost 30% of Americans' total assets, more than the combined value of equity in private businesses (17%) and retirement accounts (12%). Despite the proliferation of diversified investment options available, most people have no choice but to concentrate much of their net wealth in a single physical asset: their home.

(c) MARKET TIMING RISK: a homeowner may need to liquidate his or her largest investment as the result of an unexpected change in his/her situation (e.g. moving to take a new job) at a time when the housing market is depressed.

(d) EVENT RISK: unforeseen events (e.g., zoning changes, a new highway) can unexpectedly and significantly damage the value of a homeowner's investment. Other investments such as stocks and mutual funds can also decline in value, but a well-balanced and diversified securities portfolio has significantly lower risk concentration.

(e) RESTRICTED EXIT: Homes are highly illiquid investments. Realizing an increase in the value of a person's home has traditionally been possible only by selling or refinancing the home. For a homeowner who does not want to move and who cannot afford (or prefers not to incur) increased monthly mortgage payments, there is currently no way to benefit from an increase in a home's value. As a result, parents with college-bound children are often forced to tap home equity loans to fund the cost of higher education. Similarly, homeowners close to retirement have no significant way to diversify their assets until they sell their homes (at which point, market timing risk is significant).

Some of the conventional methods of home financing are found in the patent literature. For example, Published Patent Application No. US 2003/0236733 A1 discloses a business method for financing the purchase of real property using a conditional fee simple deed. A “conditional fee purchaser” (CFP) and a “conditional remainder purchaser” (CRP) enter into a conditional fee agreement concerning the purchase of residential property. The agreement includes a “determination date” at which time the CRP will either receive the entire fee simple interest in the real property or will receive a lump sum payment from the CFP. In general, the person who wants to buy and live in the property is the CFP, whereas a bank or other financing company becomes the CRP. There could also be some type of lender involved, including a “standard” financial institution. In some contracts, the price to be paid upon the determination date can be the “fair market value” (FMV) that would be the worth of the real property around the determination date. Alternatively, the price to be paid could be something less than the FMV, or something more than the FMV. The advantage to the CRP is that the CRP is equivalent to a landlord, however, without having any of the duties or risks of a landlord.

The advantage to the CFP is that the CFP will acquire an equity interest if the property appreciates in value at a high enough rate. The CFP may need to obtain financing from a financial institution for the CFP's initial cash that is required at the time the contract is entered into. Also, the CFP could obtain financing upon the determination date, when the CFP wishes to buy out the CRP's interest in the contract. It should be noted that, in this business method, the CFP, who resides in the subject residential property, could literally lose his or her home while still living in it, if the fee simple interest is allowed to pass in its entirety to the CRP on the determination date. In other words, if the CFP cannot afford to buy out the CRP's interest, then the CFP better plan on moving. On page 6, an example is given as to the types of money or percentages that might be involved. In this example, the CFP provides 35% of the sale price to the home, while the CRP provides 65% of the sale price. The CFP would typically find some type of financing through a financial institution for a length of time that would be no greater than the length of time up to the determination date. In this example, the determination date was only five (5) years in the future. Also in this example, the CFP must pay $110,000.00 to the CRP at that five year date to avoid losing the CFP's interest in the real property. Alternatively, the CFP can pay $10,000.00 less than the FMV at the determination date. Of course, that is an indeterminate amount at the time of the initial signing of the contract, since the fair market value is not known until later.

U.S. Pat. No. 6,345,262 discloses a method for implementing a mortgage plan. In this invention, the mortgage document creates a promissory obligation by the borrower to share with the lender a certain predetermined percentage of the realized appreciation when the property is later sold. The “equity participation mortgage obligation” is part of the mortgage plan, and specifies that the lender may share any predetermined percentage of the later realized appreciation. However, periodic payments on the mortgage must be made; this is not simply a plan to share future appreciation of the home value. In one embodiment, the mortgage documents do not require the borrower to pay interest on the mortgage principle amount. Moreover, the mortgage document may limit the lender's predetermined percentage of the realized appreciation on a later sale to a specified percentage of the total realized appreciation value.

U.S. Pat. No. 5,983,206 discloses a computerized system for creating a mortgage partnership, in which there are two parts to the mortgage: a “Section A and a Section B.” The Section A portion has the characteristics of a conventional mortgage (either fixed-rate or adjustable) and can be marketed separately from the Section B portion. The Section B part of the mortgage has both debt and joint venture equity. The debt principal reflects amount of capital contributed to the house financing by the Section B owner, which is the price of the house, less the down payment, and less the Section A principal. The value of the Section B equity share can increase over the life of the mortgage because of the Section A mortgage payments, and also if the house equity goes up. In one example discussed in this patent, the inventor uses a twenty year mortgage, in which the Section A mortgage payments run for fifteen years, while the Section B holder must wait until that fifteen years is up before receiving any repayment. The Section B owner is a joint venture partner and holds shares in the total value of the house, including any appreciation (or depreciation) in its value. Its equity percentage is typically 50%. Both the Section A and Section B owners hold mortgages, and the home owner must make periodic payments to both of these Section A and Section B mortgagees, one at a time.

U.S. Pat. No. 5,950,175 discloses a data processing system for managing real estate “swap” accounts. Each account can provide a “swap” between a property holder and the plan manager in which the property holder dilutes his or her exposure to the real estate market by exchanging future appreciation of the property for a current cash flow stream. The managing system can implement packaging of numerous of these accounts into baskets of real estate assets, and can sell the real estate exposure to the institutional market. More specifically, a cash stream at a fixed rate is exchanged for a future stake in the appreciation of the property. In effect, the property holder is trading a stake in their property value for a fixed income return. When the property is sold, the incremental appreciation of the property is applied as a percentage to the original owner and a percentage to the plan manager, corresponding to their original stakes. This could be used for pension fund managers, as well as other institutional entities. One example given in column 3 is where the home purchase price was $100,000.00: the owner would contract away 50% of the appreciation of this home in exchange for a fixed income on 50% of the purchase price (i.e., $50,000.00). The exposure of $50,000.00 worth of real estate thus is being swapped for a fixed return, similar to that of a bond.

It would therefore be an improvement to provide a method of financing for real property, such as housing or individual homes, in which the initial investment can be lessened with regard to the down payment, and at the same time allow the home buyer or home owner to somewhat diversify his or her investment. It would be another improvement to provide a method of financing for real property, such as individual homes, in which the home buyer or home owner is able to receive financing that does not involve periodic pre-determined principal or interest payments. It would be another improvement to provide a method of financing for real property, such as individual homes, in which the homeowner is able to receive cash in exchange for part of his or her equity interest in the home (while still living in the home), and which does not involve periodic pre-determined principal or interest payments by the homeowner.

### SUMMARY OF THE INVENTION

Accordingly, it is an advantage of the present invention to provide a methodology for creating an equity financing right in a property, in which an equity financing provider supplies monetary consideration to a prospective purchaser or an existing owner of the property, and in exchange the equity financing provider receives a right to a portion of the future change in value of the property.

It is another advantage of the present invention to provide an investment vehicle for allowing equity financing providers to buy and sell equity financing rights in one or more properties, and the general public and institutions to invest in securities issued by one or more equity financing providers that have obtained such equity financing rights.

It is yet another advantage of the present invention to provide a computer apparatus that is used for determining the price of an equity financing right, in which the computer receives input data representing the sale price of a property to be sold to a buyer, a down payment amount, and an appraisal value of the property, and then to determine whether or not the property qualifies for equity financing, and if so, to then determine an amount representing the equity financing amount that will be conditionally offered by an equity financing provider to the buyer in exchange for an equity financing right, which represents a percentage share of the future change in value of the property. The computer apparatus can be connected to a network of computers, all of which can communicate with a database containing the pertinent information.

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a method for financing property is provided, in which the method comprises the following steps: (a) a buyer preparing to purchase a real estate property from a seller for a purchase price, in which the purchase price includes a loan amount and a down payment amount; (b) supplying from the buyer a first portion of the down payment amount, wherein the down payment amount is less than the purchase price; (c) supplying a loan amount from a financial institution, wherein the loan amount is less than the purchase price, and wherein the buyer is obligated to pay the loan amount back to the financial institution by way of at least one payment at a later time; and (d) supplying a remaining, second portion of the down payment amount from an equity financing provider, wherein the equity financing provider receives an equity financing right from the buyer to receive in the future a percentage share of a change in value of the real estate property.

In accordance with another aspect of the present invention, a method for making an equity withdrawal is provided, in which the method comprises the following steps: (a) an owner of a real estate property requesting a monetary amount from an equity financing provider; and (b) supplying the monetary amount at a first date from the equity financing provider, wherein the equity financing provider receives an equity financing right from the owner to receive at a second date a percentage share of a change in value of the real estate property at the second date; wherein: (c) no periodic payments are to be received by the equity financing provider from the property owner during a time interval between the first date and the second date; and (d) the equity financing provider does not have a right to assume total ownership of the real estate property at the second date.

In accordance with yet another aspect of the present invention, a method for creating an investment vehicle in a plurality of equity financing rights is provided, in which the method comprises the following steps: (a) providing at least one equity financing provider to supply monetary capital in a form of equity financing; (b) supplying equity financing, from the at least one equity financing provider, to a plurality of real estate property buyers/owners, for which in exchange the at least one equity financing provider receives at least one of a plurality of equity financing rights from at least one of the plurality of real estate property buyers/owners, and thereby receiving in the future a percentage share of a change in value of at least one of the plurality of properties; (c) creating an investment vehicle that comprises at least a portion of the at least one of the plurality of equity financing rights; and (d) allowing at least one third party to invest in the investment vehicle.

In accordance with still another aspect of the present invention, a computer apparatus used for determining a price of an equity financing right is provided, which comprises: (a)

a memory circuit for storage of data, the memory circuit containing a quantity of random access memory (RAM) and a bulk memory storage device; (b) a processing circuit that is configured to manipulate data in the memory circuit, and to: (i) receive as input data a first amount representing a sale price of a real estate property to be sold to a buyer; (ii) receive as input data a second amount representing a down payment amount; (iii) receive as input data a third amount representing an appraisal value of the real estate property; (iv) determine whether or not the real estate property qualifies for equity financing, based upon the first amount, the second amount, and the third amount; and (v) determine a fourth amount representing an equity financing amount that is conditionally offered by an equity financing provider to the buyer, in exchange for an equity financing right from the buyer to receive in the future a percentage share of a change in value of the real estate property.

In accordance with a further aspect of the present invention, a computer apparatus used for determining a price of an equity financing right is provided, which comprises: (a) a memory circuit for storage of data, the memory circuit containing a quantity of random access memory (RAM) and a bulk memory storage device; (b) a processing circuit that is configured to manipulate data in the memory circuit, and to: (i) receive as input data a first amount representing an appraisal value of a real estate property; (ii) determine whether or not the real estate property qualifies for equity financing, based upon the first amount; and (iii) determine a second amount representing an equity financing amount that is conditionally offered by an equity financing provider to an existing owner of the real estate property, in exchange for an equity financing right from the owner to receive at a future date a percentage share of a change in value of the real estate property.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a flow chart showing steps used in the application process for a combination of mortgage/equity financing, as according to the principles of the present invention.

FIG. 2 is a flow chart showing steps used in the application process for equity financing only, as according to the principles of the present invention.

FIG. 3 is a flow chart showing steps involving home improvements after equity financing has been obtained on a property, as according to the principles of the present invention.

FIG. 4 is a flow chart showing steps for refinancing a home after equity financing has been obtained for that home, as according to the principles of the present invention.

FIG. 5 is a flow chart showing steps used for an early redemption of an equity financing right, as according to the principles of the present invention.

FIG. 6 is a flow chart showing steps used upon the sale of a home when an equity financing interest (or right) is involved, as according to the principles of the present invention.

FIG. 7 is a flow chart showing steps that may lead to termination of an equity financing interest (or right), as according to the principles of the present invention.

FIG. 8 is a block diagram of a computerized system that may be used in implementing the present invention.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

In the present invention, a form of real property financing is presented which is generally referred to herein as “equity financing” which creates an “equity financing right”. Another term for this type of equity financing is a phrase: “Home Equity Appreciation RighT”, (or HEART™). This HEART form of equity financing represents a new approach to home financing, and provides a solution to the drawbacks of traditional home equity investment.

### How the HEART-Style Equity Financing Works

### EXAMPLE #1

For example, a couple wishes to purchase a home for $170,000. In order to secure a commitment from a lender for an 80% mortgage, the couple needs a $34,000 down payment. In one mode of the present invention, an “equity financing provider” entity (e.g., a fictitious company called HEART Investments Corporation) can provide a portion of the required down payment in return for a quantity referred to herein as the “equity financing,” or sometimes referred to as a “Home Equity Appreciation RighT” (or “HEART”). In this example, assume the equity financing amount is $17,000, which is 50% of the “normal” $34,000 down payment amount, so that the home purchase is financed as stated in TABLE #1, as follows:

TABLE #1

| | |
|---|---|
| Mortgage loan | $136,000 |
| Equity invested in home | |
| HEART | $17,000 |
| Homeowner down payment | $17,000 |
| | $34,000 |
| Total investment in home | $170,000 |

In one mode of the present invention, when the home is re-sold at a later date, the proceeds of the re-sale are paid out in the following order:

(1) Any outstanding mortgage balance is paid off.

(2) The equity financing provider receives back its original investment ($17,000).

(3) The homeowners receive back their $17,000 down payment, plus the amount by which the mortgage balance has been paid down since the home was purchased.

(4) The homeowners and the equity financing provider share any remaining proceeds 50:50.

The math works as follows, as seen in TABLE #2 below; this example assumes that the house is sold for $200,000, a gain of $30,000 over its purchase price:

TABLE #2

| | |
|---|---|
| Proceeds from sale of house | $200,000 |
| 1. Payment to mortgage lender⁽¹⁾ | $(70,000) |
| 2. Repayment of HEART investment | $(17,000) |
| 3A. Repayment of down payment | $(17,000) |
| 3B. Mortgage principal paid down since purchase | $(66,000) |
| 4A. HEART share of equity | $(15,000) |
| appreciation | |
| 4B. Homeowners' share of equity appreciation | $(15,000) |

⁽¹⁾The example in TABLE #2 assumes that, by the time the house is re-sold, the initial mortgage balance has been paid down from $136,000 to $70,000.

Impact on the homeowner: the equity financing used in the present invention may give rise to certain questions in the minds of the consumer HBO (home buyer, or home owner). For example:

(a) Does selling an equity financing right (e.g., a HEART-type right) in a person's home mean that the HBO will not gain from a rise in the home's value? The answer is NO: with the (HEART-type) equity financing right of the present invention, the HBO retains a 50% interest in any appreciation in his home's value (using the numbers in EXAMPLE #1, above). The HBO will also accumulate the value of the mortgage principal which is paid down during the life of the (HEART-type) equity financing right.

(b) Does selling an equity financing right (a HEART-type right) mean that the HBO loses the ability to deduct mortgage and property taxes for income tax purposes? Answer: NO. With the (HEART-type) equity financing methodology of the present invention, the HBO should have the same ability to deduct these payments with or without the (HEART-type) equity financing.

Examples of persons who can benefit from the equity financing method (the “HEART” method) of the present invention include:

(a) Homebuyers (HBO's) seeking to purchase a bigger house than they can afford with a conventional mortgage.

(b) Homebuyers (HBO's) seeking a lower cost alternative to financing their home with a mortgage of greater than 80% of the home's price. By utilizing a non-interest bearing source of finance, homebuyers can reduce their monthly financing cost. For example, on a $170,000 home financed with a 30-year 7% fixed rate mortgage, the monthly payment would be $160 more with a 90% mortgage (including PMI) than with an 80% “mortgage-plus-HEART” combination.

(c) Homeowners (HBO's) considering a home equity loan. A HEART-type source of equity financing can be used to fund college expenses, a new car, a home improvement, etc., without increasing the homeowner's monthly payments.

(d) Individuals seeking to finance vacation properties and second homes.

(e) Homeowners (HBO's) seeking ways to reduce the amount of their net worth which would otherwise be tied up in a single asset, i.e., to diversify their net worth. An example of such persons may be so-called “empty nesters” who are close to retirement, and who expect to move to a smaller property within a few years.

(f) Heirs to a family home who wish to keep the home but need cash resources, either to settle estate taxes, or to buy out the part interests in the home owned by other heirs (e.g., a sibling) who wish to sell the asset.

### Investing in HEART-Type Equity Financing:

An untapped asset class: at almost $4 trillion, owner-occupied home equity represents one of the largest pools of assets in the United States. Despite the size and strong performance of the housing market, historically the only way to invest in home equity directly has been to own property. Owning residential property has a number of disadvantages as an investment vehicle, principally:

(1) Concentration of risk into a relatively small number of assets;

(2) High transaction costs (to buy and sell property);

(3) The on-going costs of property taxes and insurance; and

(4) The costs and administrative burden of maintaining the property.

The capital markets offer numerous real estate investment opportunities: REITs, mortgage-backed securities, the stock of mortgage lenders, realtors or homebuilders. However, no traditional form of investment security provides direct exposure to the equity portion of the underlying asset pool.

The equity financing methodology of the present invention appears to be the first investment vehicle to offer direct participation in home equity without the risk concentration, costs, or management burden of directly owning the property. Thus, the present invention can represent an attractive asset both (1) for an asset manager seeking to diversify investment holdings across a broader spectrum of the economy, and (2) for a more specialized investor interested in real estate exposure without the drawbacks of direct real estate investment.

When using the present invention as a form of creating an investment vehicle for a plurality of equity financing rights, the first step in creating the investment vehicle is to create the actual equity financing rights in a number of properties, such as real estate housing. If desired, the sole investment vehicle could be to allow the general public or institutions to buy and sell shares of a single equity financing provider. Another form of utilizing an investment vehicle would be to have one or several equity financing providers, each of which owns a number of different equity financing rights in a number of different properties, buy and sell one or more such equity financing rights among themselves, or to the general public, or to institutions. Yet another form of utilizing an investment vehicle would be for an equity financing provider to sell securities, backed by packages of different equity financing rights in a number of different properties, to the general public, or to institutions. Still another form of an investment vehicle utilizing the present invention would be to establish some type of holding company or a mutual fund, for example, that would allow the general public to invest (e.g., buy and sell) in shares of either the holding company or such mutual fund. Such holding companies or mutual funds could invest in securities issued by equity financing providers, in individual equity financing rights, or in packages of multiple equity financing rights. The buyers (e.g., the general public or institutions) of such securities or other forms of investment noted above would be providing some type of legal consideration, such as cash, or other type of monetary obligation that is backed by credit, such as a credit card, a debit card, or a bank loan. Other forms of such legal consideration could be promissory notes or bank notes, for example.

Almost any type of stock market or bond market investment vehicle could be used, such that the general public or institutions could buy or sell shares of stock or other types of notes, including bond instruments related to equity financing providers. The wider spread that the equity financing rights become, the more likely there will be several different equity financing providers, and perhaps ultimately several different equity financing provider mutual funds or bond offerings, for example. The more complicated the investment vehicle becomes, the more likely the record-keeping activities will also become complicated and probably performed on a computing system. Such a computing system would likely be used in a network of computers, and would likely have a network server and a database memory component, such as illustrated at 540 and 542 on FIG. 8. This would essentially be the same as any other type of record-keeping computer system that is already used in the stock and bond markets, and especially for those involving mutual funds.

The present invention can also represent a means for investment managers to establish or grow an investment management or mutual fund business. For example, an investment manager might suggest to a client or prospective client that he or she could use an equity financing right to raise funds which could then be placed under the manager's control. The client or prospective client would benefit from a more diversified investment portfolio (since less of his or her net worth would be concentrated in home equity), and the investment manager's business would benefit from an increase in funds under its management.

### Leveraged Returns:

Over the long term, investing in residential property has generated consistently solid returns: since 1975, an average annual growth of 5.7%, and the median US home value has never had a losing quarter. The equity return on home investments has been significantly higher. A home financed with an 80% mortgage will have delivered an equity return in the range of 11-25%, depending on how long the home was owned. This compares favorably with the public equity markets: over the same period the S&P 500 Index achieved 9.8% compound price appreciation and a 13.5% total return.

An example of return on investment for a home originally costing $120,000 is illustrated in TABLE #3, below as EXAMPLE #2:

TABLE 3
Equity Return on Investment

| | Year 0 | Year 5 | Year 10 | Year 20 | Year 30 |
|---|---|---|---|---|---|
| Home | $120,000 | $158,327 | $208,896 | $363,648 | $633,040 |
| value⁽¹⁾ | | | | | |
| Equity | $24,000 | $62,327 | $112,896 | $267,648 | $537,040 |
| value⁽²⁾ | | | | | |
| Equity | | 21.0% | 16.7% | 12.8% | 10.9% |
| ROI | | | | | |

⁽¹⁾Assumes 5.7% per year home price appreciation.
⁽²⁾Assumes a 20% “equity” down payment to purchase the home in Year 0.

The equity financing methodology of the present invention can provide an investment return on an investment in a home without the downside risk associated with assuming a mortgage to buy a house. A homeowner is financially exposed if the value of the home falls below the outstanding mortgage balance (“negative equity”); by contrast, an investment in the equity financing method risks loss of principal, but is not exposed to losses in excess of the original investment amount. In addition, the homeowner—not the investor in the HEART-style equity financing investment vehicle—remains responsible for the transactional costs of buying and selling the home, all on-going property taxes and hazard/flood insurance costs, and for maintaining the property during the lifetime of the investment.

### Portfolio Optimization for the Equity Financing Vehicle:

The value of a HEART-style equity financing portfolio can be enhanced by managing a number of key variables:

A. Average leverage: the higher the leverage of the underlying home investment (i.e., the greater the mortgage as a % of total home value), the higher the equity financing potential ROI (return on investment).

B. Average maturity: the less time the HEART-style equity financing right is outstanding, the higher its potential ROI. As the equity portion of home's value increases over time, the leveraging effect of the mortgage financing declines. HEART-style equity financing rights can be expected to deliver higher returns in areas with rapid ownership turnover (e.g., suburban starter homes in older cities).

C. Geographic exposure: heavy weighting in regions expected to experience high relative home price appreciation.

### SUMMARY OF TERMINOLOGY

HBO: home buyer or owner (typically the home resident).
MP: mortgage provider.
EFP: equity financing provider.
EF: equity financing (e.g., the HEART).
EFIPP: equity financing initial purchase price.
OHV: original home value (also referred to as the home purchase price, or appraised value in some examples below).
HI: home improvement.
RHV: redemption home value (the value at which the home could be sold, or re-financed, in some examples below).
EFRP: equity financing redemption price.

Note that the above acronyms will be used in most or all of the examples herein, even in situations where they may not seem quite appropriate. For example, the term “HBO” will be used in some examples in which the person who is interested in HEART-style equity financing is also the existing home owner, so that this person would not also be the home “buyer.” However, to be consistent in this description and in the flow charts provided herein, this person will still be referred to as an HBO (for home buyer or owner), even though it is clear that this person already owns the home and thus will not be also buying it during the particular example scenario or transaction.

Some further details about the terminology used herein:

The EFP would typically be a financial institution of a type that acts as a special purpose vehicle created to purchase equity financing rights (e.g., HEART-style rights). The initial “seller” of the equity financing rights is the prospective home buyer, or the person who already owns a home; therefore, the initial “buyer” of the equity financing rights is the EFP. However, once the equity financing rights have been established for a particular home, the EFP can then become a seller (or more accurately, a re-seller) of the equity financing rights, and a different financial institution can become the holder of the equity financing rights by purchasing those rights from the EFP.

As noted above, the HBO typically would be a home owner, or a prospective home buyer. In the examples discussed below, a person who already is the owner of a home is referred as the HBO (for “home buyer/owner”), even though that person may not buying anything at the time.

The equity financing rights (“EF rights”), sometimes referred to herein as HEART-style rights, typically refers to a non-interest bearing security that has been secured on an HBO's residential property (the “Home”), which grants EFP the right to receive a “Redemption Price” at the “Redemption Date.” The EF rights are typically subordinated to the first mortgage secured on the Home. (The provider of the first mortgage would have it no other way.) However, it will be understood that a single organization could be both the mortgage provider (MP) and the equity financing provider (EFP), if that organization chooses to be involved in both types of real estate financing. In the examples described herein, the MP and EFP are always delineated separately, as though they were two different companies in every situation. Even if a single organization owned both the mortgage and the EF rights on a particular home, these two separate investment vehicles could be assigned or sold (or otherwise encumbered) in two different manners, i.e., to two different companies, or at two different times.

The original home value (OHV) is the value of the Home at the date on which EFP purchases the EF rights. The OHV typically is determined by an appraiser, possibly the same appraiser who values the Home on behalf of the mortgage provider. The OHV will be adjusted over time by the value of any unamortized Home Improvements (HI).

Home Improvements (HI) are considered to be the value of any reasonable major home improvements undertaken by HBO between the date the EF rights are purchased and the Redemption Date; the value of HI is added to the OHV. The value of such HI is amortized over a pre-agreed amortization period (e.g., a remodeled kitchen might be valued at 100% of cost in year 1, amortized over 10 years, etc.). As described below in greater detail, prior to undertaking any major home improvements, the HBO is required to notify the EFP. In one mode of the present invention, the EFP may have the option to co-invest in the home improvement.

The initial purchase price of the EF rights (the EFIPP) does not always have to be one-half of a typical 20% down payment that may be called for when the HBO first purchases the Home. The EFIPP could be any amount or percentage of the original home value (OHV), and for example, could be in the range of 0.1-99.9% of the amount by which the OHV exceeds the mortgage outstanding on the Home at the date EFP purchases the EF rights from the HBO.

The “Redemption Date” would typically be the earliest of: (a) the sale of the Home, (b) a refinancing of the mortgage outstanding on the Home, (c) an Early Redemption, or (d) a Termination of the EF rights. These possible outcomes would be detailed in a contract between the HBO and the EFP. These possible outcomes are discussed below in greater detail.

Many homes are refinanced during the term of their initial mortgage. In the case of a mortgage refinancing, the EF rights typically would be redeemed. However, the HBO may have the option of replacing the original EF rights (subject to the EFP's approval) with a new HEART-style EF right. The terms of a new HEART-style EF right are based on the value of the Home at the date of refinancing. This situation may also be referred to as “rolling over” the equity financing on the home.

In contracts that involve HEART-style EF rights, there could be a provision (e.g., in the form of a contract) that allows the HBO to have the option of an early redemption of the EF rights contract. In this situation, the HBO may redeem the EF contract rights at any time, at a price determined by an independent appraisal of the Home's value (the “Early Redemption Value”).

In contracts that involve HEART-style EF rights, there could be a provision (e.g., in the form of a contract) that allows the EFP to terminate such rights under certain conditions. For example, if the physical condition of the Home materially deteriorates due to HBO's failure to maintain the property, then the EF rights contract may allow the EFP, after a specified notice period, to terminate the EF contract rights. Such contracts could also provide for automatic termination in the event that HBO defaults on any other mortgages or loans secured on the Home (cross default), or fails to pay property taxes when due, or for example, fails to maintain adequate hazard and flood insurance.

If a HEART-style EF rights contract is terminated, then a “Termination Value” comes into play. Upon termination, the HBO could be required to redeem the EF rights contract at a price equal to the greater of: (a) the equity financing initial purchase price (EFIPP), and (b) an Early Redemption Value (which typically would be specified in the EF rights contract).

When there is a redemption of the EF rights, a “Redemption Home Value” (RHV) comes into play. In general, the RHV is the price at which the Home is sold by the HBO to a bona fide third party. Alternatively, in the case of a Refinancing or an Early Redemption, the RHV would be the Early Redemption Value.

A “Change in Home Value” would typically be the amount by which the Redemption Home Value exceeds (or is less than) the Original Home Value, before fees, taxes and transaction costs. The EF rights (e.g., HEART-style rights) “Redemption Price” would typically be an amount equal to the EF rights Initial Purchase Price (the EFIPP), plus a percentage (e.g., in the range of 5-80%) of any Change in Home Value.

In general, the HBO would be responsible for all costs associated with buying and selling the Home (“Costs and Administration Fees”). The HBO may also be responsible for application and processing fees payable to EFP at the time the EF rights are purchased and redeemed. In most circumstances, the HEART-style EF rights would be assignable by an EFP, but not by an HBO.

When utilizing the present invention, the equity financing provider (EFP) and the home buyer or owner (HBO) do not need to determine a specific future date that would terminate the equity financing arrangement. The EF rights can thereby continue indefinitely, at least until an event occurs that would call for the redemption of those rights, which typically would be when the real estate property is sold to a third party. There are other possible redemption events, many of which are described below in detail. This aspect of the present invention is different from some of the conventional financing schemes discussed above in the BACKGROUND that are not standard mortgage packages.

When utilizing the present invention, the equity financing provider (EFP) and the home buyer or owner (HBO) generally do not need to decide upon a “guaranteed minimum exit price” that must be paid by the HBO at the time of redemption of the EF rights. In some cases, the equity financing rights might be redeemed for less than the initial amount that was provided by the EFP. Of course, this is not the preferred method of doing business for the EFP, and the contractual arrangement between the EFP and the HBO could include a provision by which the HBO cannot redeem (or otherwise terminate) the equity financing contract for less than a predetermined amount for a predetermined minimum time period. For example, if the EFP supplied $12,000 to the HBO at the time the HBO purchased a home, then the contract between the parties could stipulate that, if the HBO redeems the EF rights within five (5) years of the initial contractual date, then the HBO must pay a minimum amount of $12,000 (or some other agreed monetary value). Such a provision could be used to protect the EFP from short-term fluctuations in the real estate market.

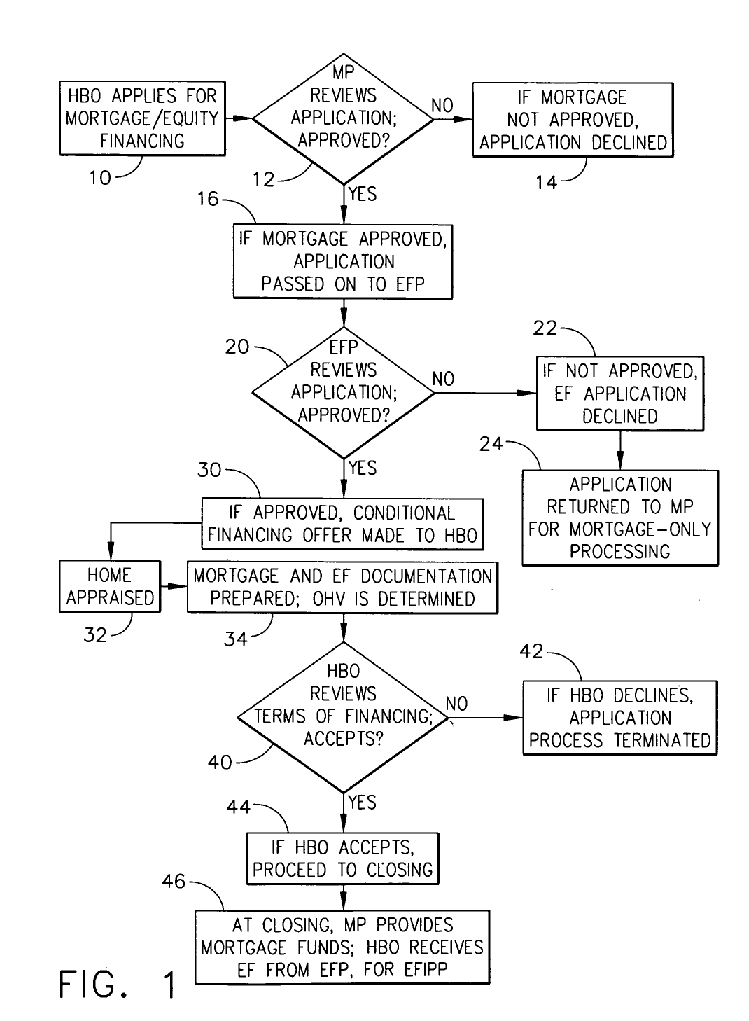

Referring now to FIG. 1, the application process for a home buyer (i.e., the HBO) who desires a combination of mortgage and equity financing is depicted as a flow chart. Beginning with a step 10, the HBO applies for mortgage/equity financing. A decision step 12 has the mortgage provider (i.e., a typical bank or savings loan institution) reviewing the application, and determining whether the application will be approved. If the answer is NO, then the mortgage is not approved and the application is declined at a step 14.

If the loan (mortgage) application is approved, a step 16 passes the application from the mortgage provider (MP) to the equity financing provider (EFP). A decision step 20 now has the EFP reviewing the application, and determining whether it will be approved. If not, a step 22 shows the equity financing application being declined, and at a step 24 the application is returned to the mortgage provider for “mortgage-only” processing.

Alternatively, if the equity financing provider approves the application at step 20, then a conditional financing offer is made to the home buyer (HBO) at a step 30. The home is then appraised at a step 32, and the mortgage and equity financing documentation are both prepared at a step 34. In addition, the “original home value” (OHV) is determined. In general, this would be the home purchase price (which typically would be considered to be “fair market value”).

At a decision step 40, the home buyer (HBO) now reviews the terms of financing and determines whether or not he or she will accept. If not, then the application process is terminated at a step 42. However, if the financing terms are accepted, then a step 44 has the HBO proceeding to closing. At a step 46, the closing occurs, the mortgage provider provides the mortgage funds, the equity financing provider provides the equity financing for the “equity financing initial purchase price” (also referred to as “EFIPP”). The HBO has now transitioned from a prospective home buyer to an actual home owner.

It will be understood that, in general, some form of collateral will be required from the HBO to secure the equity financing right. In most instances, the collateral will be the home itself. However, alternative forms of collateral might be acceptable to both the HBO and the EFP, including securities such as mutual funds or stocks, or non-security funds such as bank accounts or promissory notes. In certain instances, it may even be acceptable for the equity financing right not to be secured on any form of collateral.

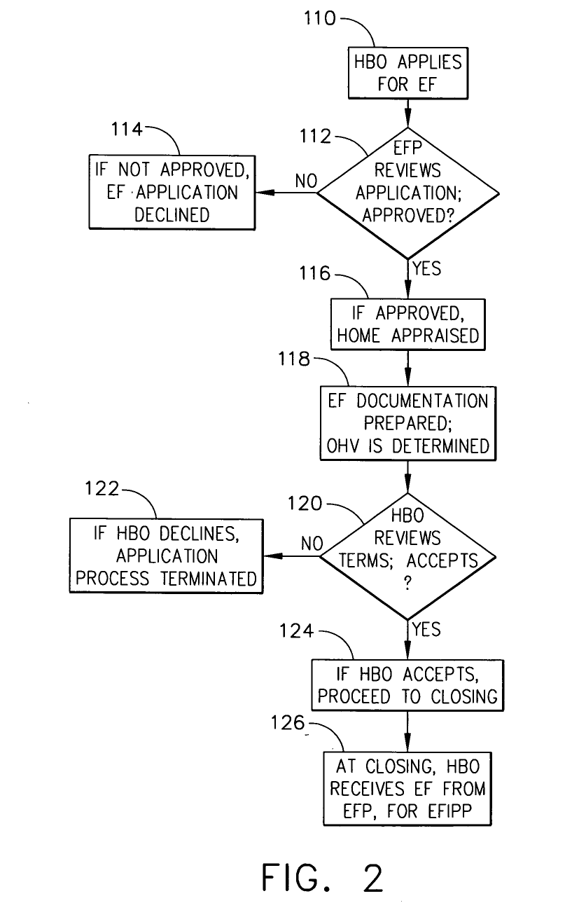

Referring now to FIG. 2, a flow chart is provided showing the application process for the equity financing only. This could occur in a situation in which a home is already owned by the HBO, and instead of applying for a second mortgage, the HBO applies for equity financing. Alternatively, it could be a situation in which a home is being purchased, but the HBO negotiates the equity financing separately from any mortgage. Starting at a step 110, the home owner (HBO) applies for equity financing, and at a step 112, the equity financing provider reviews this application and determines if it will be accepted (or approved). If not, the equity financing application is declined at a step 114.

On the other hand, if the equity financing is approved, the home is appraised at a step 116. The equity financing documentation is prepared at a step 118, and the original home value (OHV) is determined; if this is a situation where the HBO is initially purchasing the home, then the original home value (OHV) typically could be the home purchase price.

A decision step 120 has the home buyer or home owner reviewing the terms of the equity financing documentation, and determining whether or not he or she accepts. If not, the application process is terminated at a step 122. If the HBO accepts the equity financing terms, then a step 124 proceeds to closing. At a step 126, the closing occurs, the home buyer or home owner receives the equity financing amount from the equity financing provider. In this scenario, the equity financing amount is also referred to as the equity financing initial purchase price (EFIPP).

It will be understood that, when applying for a combination of mortgage/equity financing as described in FIG. 1, or when applying for equity financing alone as described in FIG. 2, the HBO's application may be non-specific as to the terms of the equity financing. Alternatively, the HBO's application perhaps may specify (i) a certain desired monetary amount, or (ii) a certain desired percentage of the future change in value of the home.

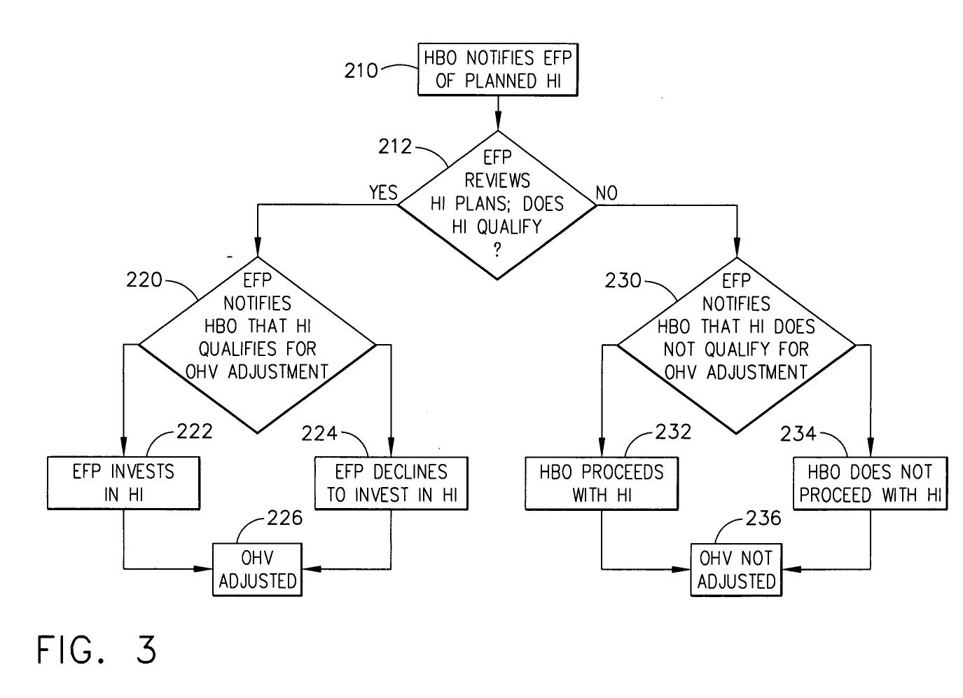

Referring now to FIG. 3, a flow chart is provided depicting the steps that occur when a home owner wants to make home improvements to his or her property. At a step 210, the home owner (i.e., the HBO) notifies the equity financing provider of a planned home improvement (HI). At a decision step 212, the equity financing provider reviews the plans for the home improvement and determines whether or not the home improvement qualifies for an adjustment in the OHV (original home value). If not, the equity financing provider notifies the HBO that the proposed home improvement does not qualify for an OHV adjustment at a step 230. The home owner now has a choice: he or she may proceed with the home improvement (at a step 232), or will not proceed with the home improvement (at a step 234). In either situation, the original home value (OHV) is not adjusted, at a step 236.

Alternatively, if the equity financing provider decides that the home improvement does qualify for an adjustment to the OHV, then at a step 220 the equity financing provider notifies the home owner that the proposed home improvement does qualify. The equity financing provider may have two choices (depending on the terms of the equity financing agreement): if permitted under the equity financing agreement, the equity financing provider may have the option to either invest in the home improvement or not. If the EFP elects to invest in the home improvement, then the EFP provides further funds. This occurs at a step 222. On the other hand, the EFP can decline to invest in the home improvement, which occurs at a step 224. In either situation, if the home improvement is actually performed, then the OHV is adjusted at a step 226. The adjusted OHV will be of some benefit to the home owner at a later time, more specifically at the time that the equity financing is later redeemed.

Note that many types of home improvements will be worth more money at one time, than at a second time. For example, a remodeled kitchen may be worth $50,000 extra to the total home value immediately after the remodeling has been finished, but five (5) years later, the remodeled kitchen may only add $25,000 to the total home value. This variable (over time) HI value is a factor that should be weighed into any OHV adjustment that might be approved by the equity financing provider. Other types of HI, such as an added room, may increase value over time.

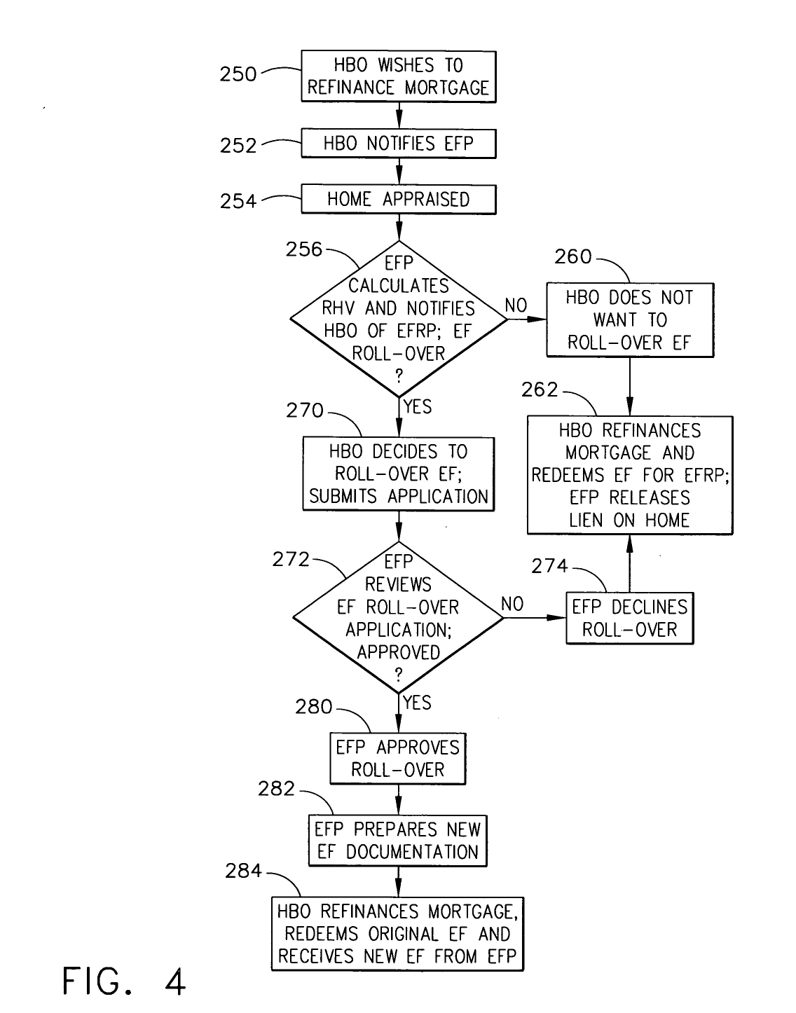

Referring now to FIG. 4, a flow chart is provided showing the steps that occur when the mortgage on the home is refinanced. Starting with a step 250, the home owner (HBO) decides to refinance his or her mortgage. As part of this process, the HBO notifies the equity financing provider of this possibility at a step 252. The home is then appraised at a step 254.

At a step 256, the equity financing provider calculates the redemption home value (RHV) and notifies the home owner of the equity financing redemption price (EFRP). Also, the home owner may have the option whether or not to roll-over the equity financing itself. If not, the logic flow is directed to a step 260 in which the home owner does not have the option, or does not wish, to roll-over the equity financing, and the home owner both refinances the mortgage and redeems the equity financing for the equity financing redemption price (EFRP), at a step 262. Upon redemption, the equity financing provider typically releases its lien on the home.

If the home owner decides that he or she wishes to roll-over the equity financing, then he or she submits an application at a step 270 for such a roll-over. At a step 272, the equity financing provider reviews the equity financing roll-over application, and determines whether or not it will be approved. If not, the equity financing provider declines the roll-over attempt at a step 274, and the logic flow is directed to step 262 in which the home owner both refinances the mortgage and redeems the equity financing for the EFRP. Upon redemption, the equity financing provider typically releases its lien on the home.

On the other hand, if the roll-over is approved for the equity financing, then the logic flow is directed to a step 280, in which the roll-over is approved by the equity financing provider. The equity financing provider now prepares new equity financing documentation at a step 282, and then at a step 284 the home owner refinances the mortgage, redeems the original equity financing, and receives a new equity financing contract from the equity financing provider.

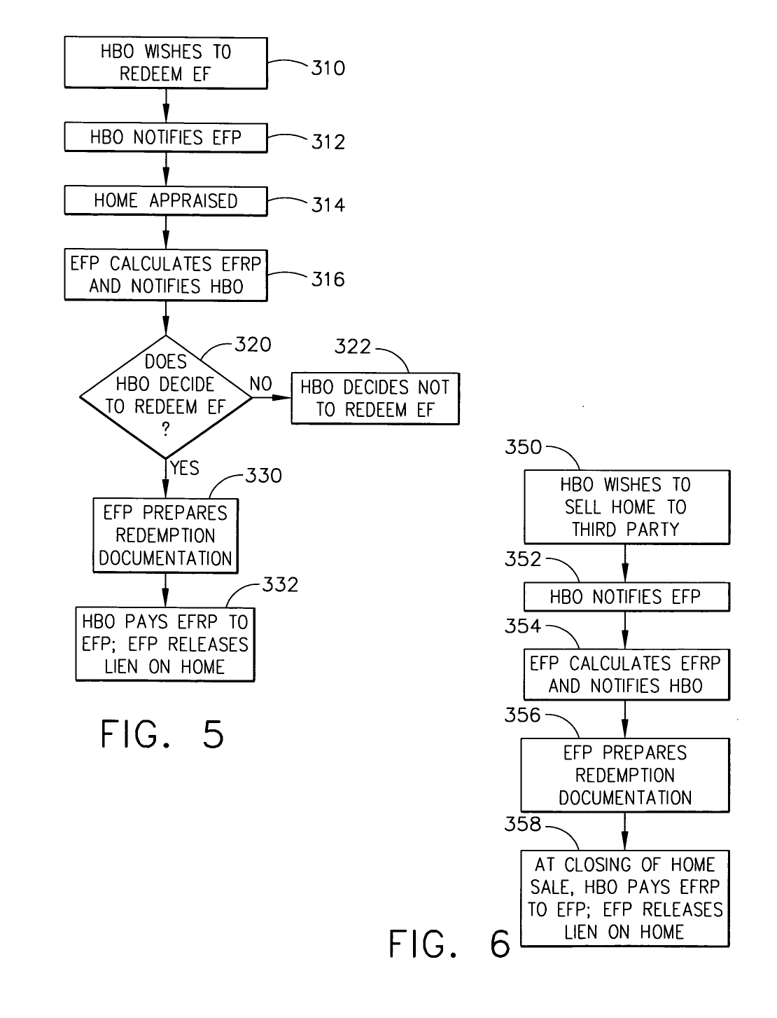

Referring now to FIG. 5, a flow chart is provided showing the steps for an early redemption of the equity financing. Starting with a step 310, the home owner (HBO) makes it known that he or she wishes to redeem the equity financing contract. This is done by the HBO notifying the equity financing provider of this possibility, which occurs at a step 312. The home is now appraised at a step 314, and at a step 316 the equity financing provider calculates the equity financing redemption price (EFRP) and notifies the home owner of that value.

At a decision step 320, the home owner now decides whether or not to redeem the equity financing rights. If not, the logic flow is directed to a step 322 in which the home owner has decided not to redeem the equity financing rights (e.g., the HEART-type financing). On the other hand, if the home owner decides to redeem the equity financing rights, then the equity financing provider prepares the redemption documentation at a step 330. At a step 332, the home owner pays the equity financing redemption price (EFRP) to the equity financing provider, and the equity financing provider releases the lien on the home.

Referring now to FIG. 6, a flow chart is provided showing the steps that occur when the home is sold. Beginning with a step 350, the home owner wishes to sell to a third party, and then notifies the equity financing provider of that situation at a step 352. The equity financing provider calculates the equity financing redemption price (EFRP), which will typically be the price at which the home is being sold to the third party, at a step 354, and notifies the home owner of that value. The equity financing provider now prepares the redemption documentation at a step 356.

Upon the closing of the home, the home owner pays the EFRP to the equity financing provider at a step 358. When that occurs, the equity financing provider releases the lien on the home.

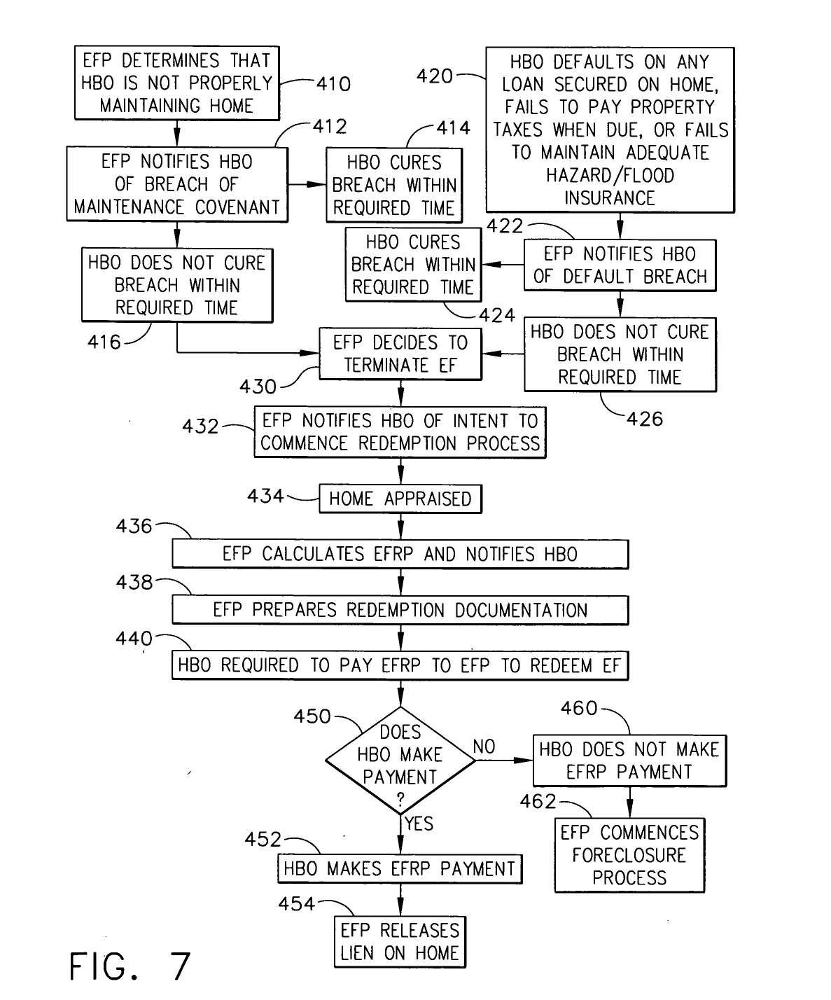

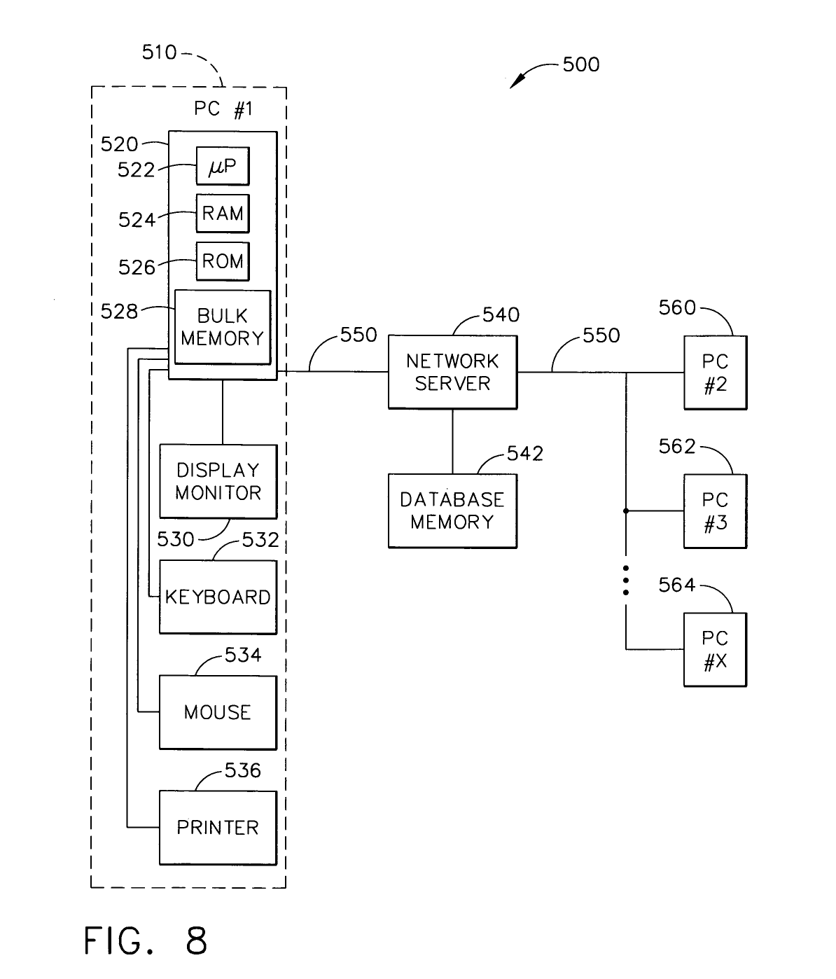

Referring now to FIG. 7, a flow chart is provided for the situation where the home owner essentially has breached the equity financing contract between the home owner and the equity financing provider. In one scenario, the equity financing provider determines that the home owner (HBO) is not properly maintaining the home, at a step 410. At a step 412, the equity financing provider notifies the home owner of a breach of the maintenance covenant of the contract between the two parties. If the home owner cures the breach within the required time, then this scenario ends amicably at a step 414. However, the home owner may not cure the breach within the required time, as shown at a step 416. In the situation where the breach is not cured, then the equity financing provider can decide to terminate the contract involving equity financing, at a step 430.

A second scenario that may lead to the conclusion that the home owner has breached the equity financing contract begins at a step 420. For example, the home owner (HBO) may have defaulted on one or more loans that have been secured on the home property. Or, alternatively the home owner may have failed to pay property taxes when due, or may have failed to maintain adequate hazard or flood insurance. When any of these events occurs, this could be a breach of the contract between the equity financing provider and the home owner. If that occurs, the equity financing provider can notify the home owner of the breach at a step 422. If the home owner cures the breach within the required time limit, then this matter is settled amicably at a step 424. However, if the home owner does not cure the breach within the required time (at a step 426), then the equity financing provider may decide to terminate the equity financing contract, at step 430.

Once the equity financing provider decides to terminate the equity financing contract, then the EF provider notifies the home owner at a step 432 of the intent to commence the redemption process. The home is appraised at a step 434, and then the equity financing provider calculates the equity financing redemption price (EFRP) and notifies the home owner of that numeric value, at a step 436. The equity financing provider now prepares the redemption documentation at a step 438.

The home owner is required to pay the EFRP to the equity financing provider, so as to redeem the equity financing rights at a step 440. However, at a decision step 450, it now is determined whether the home owner actually makes the EFRP payment to the equity financing provider. If the required payment is not made, then the logic flow is directed to a step 460, and the equity financing provider can commence a foreclosure process at a step 462. One potential result of this is that the home owner may lose his or her home.

On the other hand, if the home owner makes the EFRP payment at a step 452, then the equity financing provider will release its lien on the home at a step 454. The home owner now has been released from the obligations under the equity financing rights contract.

The example of FIG. 2 can be used in many situations. For example, a home owner may be seeking to reduce the risk of having a large portion of his or her net worth concentrated in a single asset. Such home owners may be close to retirement, and may expect to move to a smaller property within a few years. For example, an older couple may have a home worth $700,000 and have completely paid off their mortgage. This couple may also own stock, bonds, and mutual funds worth, for example, $500,000. In total, their net worth is $1,200,000, of which 58% is exposed to the value of their home. This couple could use a HEART-style equity financing scheme to decrease their exposure to the home's value, by selling an equity financing right to an equity financing provider. For example, the couple could receive equity financing for 35% of their home, which would be $245,000 of the home's $700,000 value. Their exposure to the value of their home would then fall to $455,000, or only 38% of their net worth. This same couple could also benefit from the conversion of part of their very illiquid asset (i.e., their home) into cash or other investments.

Another situation in which FIG. 2 could come into play is for heirs to a home who wish to retain the asset, but require a source of liquidity to pay inheritance taxes that might be due on the home. A son might inherit from his parents a home that has been in his family for many decades and, for example, is now worth $1,000,000. He may not wish to sell the house and see it “leave the family.” However, depending on his own financial situation and what other assets may have been left in the estate, he may not have sufficient cash to meet all the estate taxes or other related expenses that may be due. Using the present invention methodology, the son could sell an equity financing right to an equity financing provider to fund some of these expenses. For example, the son could sell 25% of the home's value, and receive $250,000 in cash which could help cover estate taxes and other expenses. The home would then stay in the family, the son would enjoy the continuing ownership of a substantial real estate asset; all of this in return for sharing with the equity financing provider 25% of any future appreciation in the value of the home.

A similar situation in which FIG. 2 might come into play would be when the home is inherited by two siblings, of whom one wishes to keep the asset and the other wishes to sell it. In this scenario, the sibling wishing to keep the home may be required to make a significant cash outlay to buy out the other sibling's interest. Instead of tapping a savings account or raising money through a mortgage loan secured on the inherited home, the sibling wishing to retain the asset might sell an equity financing right to raise a sufficient cash amount to buy out the interest of the sibling wishing to sell his or her stake.

It will be understood that the percentage share of the equity financing provider's interest in the appreciation of the home could be virtually any number between 0.1% and 99.9%. For example, if a home is being purchased, and the prospective purchaser wishes to put up a certain amount of money as a down payment and also wishes to obtain equity financing for another portion of the down payment, then the following equation would apply:

$$\% share ( owned by EFP ) = \frac{EFIPP}{non \text{-} mortgage amount provided by HBO} \qquad EQUATION \#1$$

In EQUATION #1, the non-mortgage amount typically is the non-borrowed amount that is provided by the home buyer, as his or her portion of the down payment. Later when it is time for redemption of the equity financing rights, another equation would be used to determine the equity financing redemption price (EFRP), which is provided below as EQUATION #2:

EFRP={%share(RHV−OHV)}+EFIPP. EQUATION #2

In EQUATION #2, the OHV value represents the home's value at the time the home was purchased. In general, this would be the home purchase price. The value RHV represents the home's value at the time the home is sold, or being re-financed, for example. If a home improvement has been made that was approved by the equity financing provider, then the OHV might be adjusted accordingly, such as described above in reference to FIG. 3.

In EQUATION #1, the non-mortgage amount could be 20% of the purchase price of a home, for example; this would be typical for a down payment in today's first mortgage loan situations. If the home purchase price is $120,000, for example, then the required down payment would be $24,000. If the equity financing provider is to supply half of the down payment (i.e., $12,000 in this example), then the EFIPP=$12,000, and the % share owned by the EFP would be $12,000 divided by $24,000, or 50%. This would be a typical transaction between a prospective home buyer (i.e., the HBO) and the equity financing provider (EFP). Of course, other percentages could be used for these transactions, if desired by the HBO and EFP.

Another example for using the present invention is the situation in which a person who already owns a home wishes to obtain equity financing in the form of a “home equity withdrawal.” This would be similar to a home owner obtaining a second mortgage, or a home equity line of credit; but instead of obtaining that type of loan from a “standard” banking institution or savings and loan institution, the home owner comes to an equity financing provider to obtain the type of equity financing that is obtainable using the methodology of the present invention. Home equity withdrawal transactions include the situation described above for the “empty nesters,” who wish to obtain cash, and trade a portion of the future appreciation of their home's value for this cash amount. However, they will not have any periodic interest or principal payments when using the methodology of the present invention.

The home equity withdrawal situation would involve an EQUATION #3 stated below:

$$\% share ( owned by EFP ) = \frac{EFIPP}{value of HBO ' s unencumbered interest} \qquad EQUATION \# 3$$

It should be noted that it may not be the home's entire value that is used for calculating the EFP's % share of the appreciation of the home's value. If the home owner has taken other loans on the home property (e.g., a second mortgage, or a mechanic's lien), then those types of unpaid loans are not counted in favor of the home owner. In fact, it would be the opposite: it is only the home owner's unencumbered (or “equity”) interest in the property that is used as the denominator in the calculation for EQUATION #3.

Once the home equity withdrawal is made, the equity financing provider now has a right in the future appreciation of this home's value. Upon redemption of the equity financing rights at a later time, then EQUATION #2, stated above, would be used.

It should be noted that the result of EQUATION #3 could be different than that described above, which was for a general case. One simple way to change the result is to adjust the valuation of the unencumbered interest in the property. The appraisal value of the property will be important at this stage. Of course, this unencumbered interest monetary value would have to be acceptable to both the home owner and the equity financing provider, or the deal would fall through.

FIG. 8 illustrates a block diagram of a typical computerized system that implements the present invention, generally designated by the reference numeral 500. An administrator for an equity financing provider (someone akin to a “loan officer” of a bank, for example) can be using a first workstation or personal computer, designated by the reference numeral 510, and referred to on FIG. 8 as “PC#1”.

Typical equipment within PC#1 would be an actual personal computer, generally designated by the reference numeral 520. Within the personal computer 520 would typically be a microprocessor 522, Random Access Memory (RAM) 524, Read Only Memory (ROM) 526, and a bulk memory device 528, such as a hard disk drive. The workstation or PC station 510 would typically also include a display monitor 530, a keyboard 532, a mouse 534, and perhaps a printer 536.

In a medium to large organization, such as an equity financing provider company with several employees or a mutual fund company that manages a fund that invests in one or more equity financing securities or provider companies, a typical computer system would include multiple personal computers (or workstations) that would have access to the database information utilized in the present invention. In such organizations, the database would typically be accessible over a network. As depicted on FIG. 8, a network server 540 is used to communicate over a network 550 to PC#1. The same network 550 can also be used to communicate to other workstations or personal computers, in situations where there are multiple administrators who are allowed to access some or all of the information used in the present invention.

The network server 540 may include some type of bulk memory storage devices, and would typically include or communicate with a database memory at 542 that stores most or all of the client information and other numeric and text information used in the present invention (e.g., one or more home owners/buyers, or investment clients). In this manner, all of the PCs or workstations could access the database memory 542, via the network server 540.

Note that the network 550 could comprise, at least in part, the INTERNET; in that instance, network server 540 could act as an Internet Service Provider (ISP) to allow “external” communications to and from the database 542. As an alternative (or in addition to), there could be several other ISP's located around network 550 as well, perhaps one ISP for each of the PC's or workstations (or one ISP per physical grouping thereof) that are connected to network 550. Such communications would likely be encrypted, particularly if a relatively non-secure network of computers is actually used (such as the INTERNET).

The other PCs are designated at reference numerals 560, 562, and 564. As is made clear on FIG. 8, there can be any number of such PCs or workstations, from PC#1 through PC#X. The only true limitation is the amount of physical hardware, and the network server software and hardware connections. The actual number of persons who would have access to the more confidential aspects of the information in the database 542 would typically be limited to certain higher-level managers or other senior investment advisers, or perhaps a single system administrator.

In a typical mutual fund investment vehicle example, there would likely be multiple brokers or investment advisors that will need access to some (or all) of the information in the database. Specific personal identity information probably would be available to only those persons who are involved with the appropriate specific individuals. In a typical equity financing provider company, there would likely be multiple “equity financing officers” who would need access to much (or all) of the information in the database, at least for the properties that have already had equity financing rights established thereon, or for prospective such properties, along with appropriate information about the corresponding HBO's.

It will be understood that the equity financing arrangement of the present invention could be used with all types of real estate property in addition to individual houses, such as apartment buildings, duplexes, condominiums, commercial office buildings, and perhaps even industrial buildings and other structures. The typical down payment and loan percentages might change for non-individual housing, and some of the terminology might change—the encumbrance on the investment property may not be referred as a “mortgage” in some cases; for example, it might be referred to merely as a type of “lien.”

It will also be understood that the logical operations described in relation to certain steps in the flow charts of FIGS. 1-7 can be implemented using sequential logic, such as by using microprocessor technology, or using a logic state machine, or perhaps by discrete logic; it even could be implemented using parallel processors. One preferred embodiment may use a microprocessor or microcontroller (e.g., microprocessor 522) to execute software instructions that are stored in memory cells within an ASIC, or the processing device (or processing “unit”) may comprise a stand-alone processing circuit as part of a workstation or a personal computer. Of course, other types of circuitry could be used to implement these logical operations depicted in the drawings without departing from the principles of the present invention.

It will be further understood that the precise logical operations depicted in the flow charts of FIGS. 1-7, and discussed above, could be somewhat modified to perform similar, although not exact, functions without departing from the principles of the present invention. The exact nature of some of the decision steps and other commands in these flow charts are directed toward specific types of business transactions involving equity financing rights, and certainly similar, but somewhat different, steps could be performed (or performed in a different order), with the overall inventive results being the same.

All documents cited in the Detailed Description of the Invention are, in relevant part, incorporated herein by reference; the citation of any document is not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the preferred embodiment(s), are possible in light of the above teachings, without departing from the spirit and scope of the present invention. The embodiment(s) was chosen and described in order to illustrate the principles of the invention and its practical application to thereby enable one of ordinary skill in the art to utilize the invention in various embodiments and with various modifications as are suited to particular uses contemplated. It is intended to cover in the appended claims all such changes and modifications that are within the scope of this invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A computer apparatus used for determining a price of an equity financing right, said computer apparatus comprising:
(a) a memory circuit for storage of data, said memory circuit containing a quantity of random access memory (RAM) and a bulk memory storage device;
(b) a processing circuit that is configured to manipulate data in said memory circuit, and to:
(i) receive as input data a first amount representing a sale price of a real estate property to be sold to a buyer;
(ii) receive as input data a second amount representing a down payment amount;
(iii) receive as input data a third amount representing an appraisal value of said real estate property;
(iv) determine whether or not said real estate property qualifies for equity financing, based upon said first amount, said second amount, and said third amount; and
(v) determine a fourth amount representing an equity financing amount that is conditionally offered by an equity financing provider to said buyer, in exchange for an equity financing right from said buyer to receive in the future a percentage share of a change in value of said real estate property.

28. The computer apparatus as recited in claim 27, wherein said buyer is also obligated to redeem said equity financing right, at a later time.

29. The computer apparatus as recited in claim 27, wherein said change in value of the real estate property is substantially equal to a difference between a first quantity and a second quantity, wherein: (a) said first quantity comprises a value of the real estate property determined by both said equity financing provider and said buyer when the equity financing was initially provided; and (b) said second quantity comprises a value of the real estate property at a later time when the equity financing is redeemed.

30. The computer apparatus as recited in claim 29, wherein: (a) said first quantity comprises one of: (i) a purchase price of the real estate property when the equity financing was initially provided, and (ii) an agreed value of the real estate property that differs from said purchase price; and (b) said second quantity comprises one of: (i) a sale price of the real estate property if it is sold, and (ii) an appraisal value of the real estate property if it is not sold at the time the equity financing is redeemed.

31. The computer apparatus as recited in claim 27, wherein said percentage share is substantially equal to said fourth amount divided by the down payment amount.

32. The computer apparatus as recited in claim 31, wherein a redemption amount to be paid at a later date by said buyer to said equity financing provider is substantially equal to: {(said percentage share) times (said change in value of said property)}plus {said fourth amount}.

33. A computer apparatus used for determining a price of an equity financing right said computer apparatus comprising:
(a) a memory circuit for storage of data, said memory circuit containing a quantity of random access memory (RAM) and a bulk memory storage device;
(b) a processing circuit that is configured to manipulate data in said memory circuit, and to:
(i) receive as input data a first amount representing an appraisal value of a real estate property;
(ii) determine whether or not said real estate property qualifies for equity financing, based upon said first amount; and
(iii) determine a second amount representing an equity financing amount that is conditionally offered by an equity financing provider to an existing owner of said real estate property, in exchange for an equity financing right from said owner to receive at a future date a percentage share of a change in value of said real estate property.

34. The computer apparatus as recited in claim 33, wherein:
(a) no periodic payments are to be received by said equity financing provider from said owner during a time interval between the date said equity financing right is established and said future date; and
(b) said equity financing provider does not have a right to assume total ownership of the real estate property at said future date.

35. The computer apparatus as recited in claim 33, wherein said owner is also obligated to redeem said equity financing right, at said future date.

36. The computer apparatus as recited in claim 33, wherein: said change in value of the real estate property is substantially equal to a difference between a first quantity and a second quantity, wherein: (a) said first quantity comprises a value of the real estate property determined by both said equity financing provider and said owner upon first date when said equity financing right is established; and (b) said second quantity comprises a value of the real estate property upon a second date when the equity financing is redeemed.

37. The method as recited in claim 36, wherein: (a) said first quantity comprises an agreed value of the real estate property when the equity financing was initially provided; and (b) said second quantity comprises one of: (i) a sale price of the real estate property if it is sold, and (ii) an appraisal value of the real estate property if it is not sold at the time the equity financing is redeemed.

38. The computer apparatus as recited in claim 33, wherein: said percentage share is substantially equal to said second amount divided by an unencumbered value of said real estate property at the time when the equity financing right was established.

39. The computer apparatus as recited in claim 38, wherein: a redemption amount to be paid at a later date by said owner to said equity financing provider is substantially equal to: {(said percentage share) times (said change in value of said real estate property)} plus {said second amount}.

40. A computer apparatus used for determining an amount of an equity financing right pertaining to a real estate property, said computer apparatus comprising:
(a) a memory circuit for storage of data, said memory circuit containing a quantity of random access memory (RAM) and a bulk memory storage device; and
(b) a processing circuit that is configured to manipulate data in said memory circuit, and to:
(i) receive as input data a first numeric value representing a monetary amount being requested as an equity withdrawal by an owner of a real estate property;
(ii) receive as input data a first date representing a time when said monetary amount is to be supplied to said owner by an equity financing provider, wherein said equity financing provider is to receive an equity financing right;
(iii) receive as input data a second numeric value representing, as of said first date, a value of said real estate property as determined by both said owner and said equity financing provider; and
(iv) determine, as of said first date, a third numeric value representing said equity financing right in the form of a percentage share of a change in value of said real estate property between said first date and a future, second date, which is offered to said equity financing provider by said owner, and to be redeemed at said second date;
wherein: no periodic payments are to be received by said equity financing provider from said property owner during a time interval between the first date and the second date; and said equity financing provider does not have a right to assume total ownership of the real estate property at said second date.

41. The computer apparatus as recited in claim 40, wherein said owner is obligated to redeem said equity financing right, at a later time.

42. The computer apparatus as recited in claim 41, wherein said later time comprises said second date.

43. The computer apparatus as recited in claim 40, wherein said change in value of the real estate property is substantially equal to a difference between said second numeric value and a fourth numeric value, wherein: said fourth numeric value comprises a monetary value of the real estate property upon said second date when the equity financing right is redeemed.

44. The computer apparatus as recited in claim 43, wherein: (a) said second numeric value ,comprises an agreed value of the real estate property when the equity financing was initially established; and (b) said fourth numeric value comprises one of: (i) a sale price of the real estate property if it is sold, and (ii) an appraisal value of the real estate property if it is not sold at the time the equity financing right is redeemed.

45. The computer apparatus as recited in claim 40, wherein: said percentage share is substantially equal to said monetary amount divided by an unencumbered value of said real estate property at the time when the equity financing right was established.

46. The computer apparatus as recited in claim 45, wherein: a redemption amount to be paid at a later date by said owner to said equity financing provider is substantially equal to: {(said percentage share) times (said change in value of said property)} plus {said monetary amount}.

47. The computer apparatus as recited in claim 40, wherein: there is no predetermined rime when said equity financing right must be redeemed.

48. The computer apparatus as recited in claim 40, wherein: there is no guaranteed minimum exit price when redeeming said equity financing right.

49. The computer apparatus as recited in claim 40, wherein: there is no guaranteed minimum exit price when redeeming said equity financing right, except for a predetermined time period after creating said equity financing right.

50. The computer apparatus as recited in claim 40, wherein said second numeric value may be adjusted by a home improvement to said real estate property, made between said first date and said second date.

51. The computer apparatus as recited in claim 29, wherein said first quantity may be adjusted by a home improvement made to said real estate property.

52. The computer apparatus as recited in claim 36, wherein said first quantity may be adjusted by a home improvement to said real estate property, made between said first date and said second date.
